(19) United States
(12) Patent Application Publication
(10) Pub. No.: US 2019/0069354 A1
(43) Pub. Date: Feb. 28, 2019

(54) MICROWAVE FEED DEVICE ON A MICROWAVE OVEN

(71) Applicant: Vorwerk & Co. Interholding GmbH, Wuppertal (DE)

(72) Inventor: Hendrik KOETZ, Wetter (DE)

(73) Assignee: Vorwerk & Co. Interholding GmbH, Wuppertal (DE)

(21) Appl. No.: 16/108,586

(22) Filed: Aug. 22, 2018

(30) Foreign Application Priority Data
Aug. 23, 2017 (EP) 17187390.4

(51) Int. Cl. H05B 6/68; H05B 6/70

(52) U.S. Cl. CPC H05B 6/68; H05B 6/707; H05B 6/705

(57) ABSTRACT

A device and a method for feeding power in the form of an electromagnetic alternating field, which is generated by a microwave transmitter, into a cooking chamber of a microwave oven, wherein the electromagnetic alternating field is transmitted in a power flow direction by a transmission device from the microwave transmitter to a plurality of feed points of the cooking chamber, wherein the transmission device has at least one waveguide and a coupling element, which is coupled to the waveguide, wherein the coupling element, which is embodied as power distributor, connects the microwave transmitter to a plurality of waveguides. The coupling element is a coupling pin, which has a plurality of arms.

### CROSS REFERENCE TO RELATED APPLICATIONS

Applicant claims priority under 35 U.S.C. § 119 of European Application No. 17187390.4 filed on Aug. 23, 2017, the disclosure of which is incorporated by reference.

### BACKGROUND OF THE INVENTION

### 1. Field of the Invention

The invention relates to a device for feeding an electromagnetic alternating field, which is generated by a microwave transmitter, into a cooking chamber of a microwave oven, wherein the electromagnetic alternating field is transmitted in a power flow direction by means of a transmission device from the microwave transmitter to a plurality of feed points of the cooking chamber, at which the electromagnetic power, which is generated by the microwave transmitter, is fed into the cooking chamber, wherein the transmission device has at least one waveguide and a coupling element, which is coupled to the waveguide, wherein the coupling element, which is embodied as power distributor, connects the microwave transmitter to a plurality of waveguides.

The invention furthermore relates to a method for operating such a device.

### 2. Description of the Related Art

Devices for feeding electromagnetic alternating fields in a cooking chamber are known under the name “microwave ovens”. The electromagnetic alternating field is generated by a microwave transmitter, which has a magnetron for this purpose. The microwaves are transmitted to a coupling element via a decoupling section. The coupling element couples the electromagnetic alternating field to a waveguide, which leads into the cooking chamber. The coupling element and the decoupling section can thereby form an impedance converter. Inside the cooking chamber, the electromagnetic waves propagate in the direction of the emission direction thereof at the feed points and are reflected repeatedly by the walls. A homogenous field distribution inside the cooking chamber does not form, so that the heating of food inside the cooking chamber does not take place homogenously. Waves forming in the cooking chamber overlap one another destructively or constructively, respectively. Hot or cold spots, respectively, remain.

To homogenize the energization of the food to be heated up, mechanical disturbing members were provided in the manner of a ceiling fan, by means of which chronologically changing reflection surfaces were created.

EP 0 284 958 A1 proposes a device for coupling a microwave field into a microwave oven, in the case of which coupling pins are provided inside a resonator chamber, which are to cause a rotation of the electromagnetic field coupled into the resonator chamber, so that unpolarized alternating field can escape from a feed opening. It is also proposed therein to connect two transmitters to a joint resonator chamber with a waveguide each, which, in turn, is coupled to the cooking chamber via a plurality of coupling openings.

Microwave ovens, in the case of which an electromagnetic alternating field is transmitted by a microwave transmitter to a plurality of feed points of the cooking chamber by means of a transmission device, are furthermore known from the publications EP 2445312 A1, EP 3151636 A1, JP 2008/269794 A and FR 1378280 A, wherein the transmission device has a waveguide and a coupling element coupled thereto, which coupling element, in turn, connects the microwave transmitter to a plurality of waveguides.

### SUMMARY OF THE INVENTION

The invention is based on the object of proposing measures, by means of which the product to be cooked, which is to be heated, is heated more evenly and thus has a more homogenous temperature distribution.

The object is solved by means of the invention specified in the claims.

The transmission device, by means of which the electromagnetic alternating field and thus the power generated by the microwave transmitter is transmitted from the microwave transmitter to the feed points, has a coupling element and a plurality of waveguides, wherein the coupling element is a coupling pin, which has a plurality of arms. The electromagnetic alternating field is fed into the coupling element and, with its help, is distributed to a plurality of waveguides, so that it can be guided into the cooking chamber on a plurality of different paths, because each waveguide leads into the cooking chamber at a feed point, which is assigned to it individually. The electromagnetic alternating field is generated for example by means of a magnetron and is fed for example into a coupling branch of the coupling element. The coupling element can have a plurality of decoupling branches, which distribute the power, which is fed into the coupling element, to the plurality of waveguides. This can take place according to a specified power distribution ratio. Preferably, the power coupled into the coupling branch is evenly transferred to all decoupling branches. The coupling element can be formed by an electrically conductive body, in particular by a metal body. One arm of the coupling element acts as coupling branch. A plurality of other arms of the coupling element act as decoupling branches. The coupling element forms a deflector, by means of which electromagnetic waves generated by a single source can be distributed to a plurality of outputs. A feed point is preferably assigned to each output. The feed points are preferably arranged on at least two walls of the cooking chamber, which are at an angle to one another. As a result of this embodiment, which in particular has a plurality of lateral feed points, it is possible to influence the constructive and destructive overlaps, which appear in the prior art and which are created by means of an overlap of the field strengths, in such a way that the electromagnetic waves essentially do not mutually extinguish one another or additively overlap one another at 100 percent, respectively, so that the formation of cold and hot zones inside the material to be cooked can be reduced by means of the device according to the invention. It is particularly advantageous for this purpose when three or more feed points are provided, which are arranged in a suitable geometric arrangement on the walls of the cooking chamber. In a further development of the invention, it is provided that the coupling element is embodied as multipath deflector. With regard to the coupling branch, the individual decoupling branches can also be brought from a power-transmitting operating position into a non-power-transmitting operating position. It is possible through this to feed the power through various feed points into the cooking chamber in chronological order, wherein it is in particular also provided that the electromagnetic alternating fields are fed into the cooking chamber one after the other through different groups of feed points. The feed points can be realized by means of openings, at which a waveguide leads into the cooking chamber in each case. Individual zones or radiation paths inside the cooking chamber can be supplied with microwave energy one after the other in a time-controlled manner through this.

### BRIEF DESCRIPTION OF THE DRAWINGS

Exemplary embodiments of the invention will be described below by means of enclosed drawings.

FIG. 1 shows a microwave oven according to the prior art in a perspective illustration,

FIG. 2 shows a microwave oven according to the prior art in a top view,

FIG. 3 shows a first exemplary embodiment of the invention, schematically in a view,

FIG. 4 shows a second exemplary embodiment of the invention, schematically in a view,

FIG. 5 shows the exemplary embodiment illustrated in FIG. 4, but approximately along the sectional line V-V in FIG. 4, and

FIG. 6 shows a coupling member of a third exemplary embodiment.

### DETAILED DESCRIPTION OF THE PREFERRED EMBODIMENTS

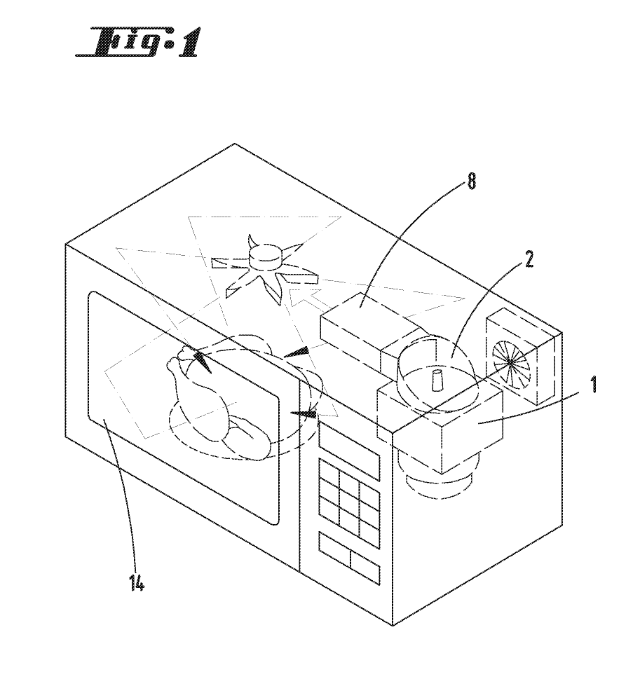

FIG. 1 shows a microwave oven according to the prior art, in the case of which a cooking chamber 14, which is defined by walls, is provided inside a housing and into which a waveguide 8, into which power in the form of an electromagnetic alternating field is coupled, leads at a feed point The electromagnetic alternating field is generated in a magnetron 1 and is coupled into the waveguide 8 via a decoupling section 2. Inside the cooking chamber 14, a multiple reflection of the propagating electromagnetic alternating field takes place. The energy transported with the electromagnetic alternating field is converted into heat inside the material to be cooked. For the homogenization of the field distribution, a paddle wheel is arranged on the ceiling of the cooking chamber 14.

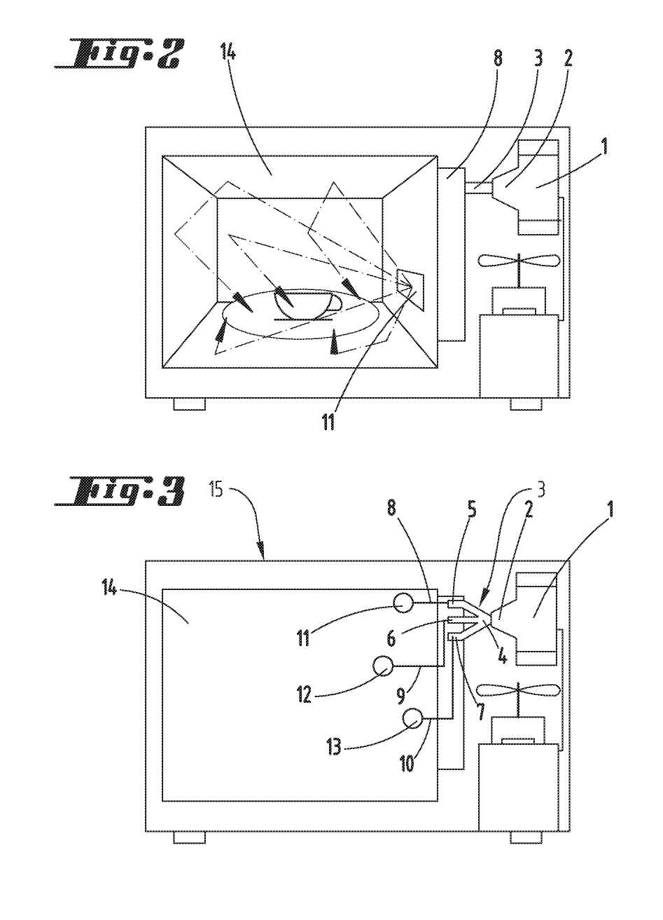

FIG. 2 shows a further microwave oven of the prior art, in the case of which the electromagnetic alternating field, which is generated by a microwave transmitter 1, 2, is coupled into a coupling element 3 in the form of a coupling pin. The coupling element 3 transmits the electromagnetic power, which is generated by the microwave transmitter 1, 2, to a waveguide 8, in which the power is transported as electromagnetic radiation to an opening in the wall of the cooking chamber 14, which represents a feed point 11.

The first embodiment of the invention illustrated in FIG. 3 has a coupling element 3, which is embodied in a bifurcated manner. It has four arms. One short coupling arm 4, which branches into three decoupling arms 5, 6, 7. The electromagnetic power, which is coupled into the decoupling arm 4, is transmitted evenly into the decoupling arms 5, 6, 7. The ends of the decoupling arms 5, 6, 7 form local sources for an electromagnetic alternating field, which is in each case transmitted to a waveguide 8, 9, 10. The waveguides 8, 9, 10 lead into the cooking chamber 14 at locations, which differ from one another. In the case of the exemplary embodiment illustrated in FIG. 3, the waveguides 8, 9, 10 lead to three feed points 11, 12, 13, which are located at various points in a side wall.

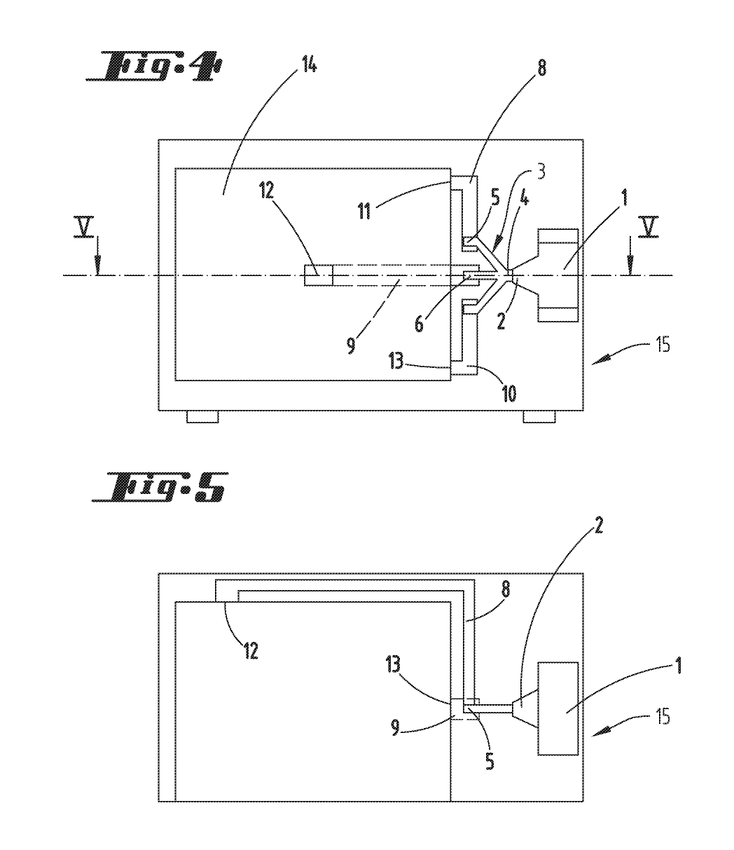

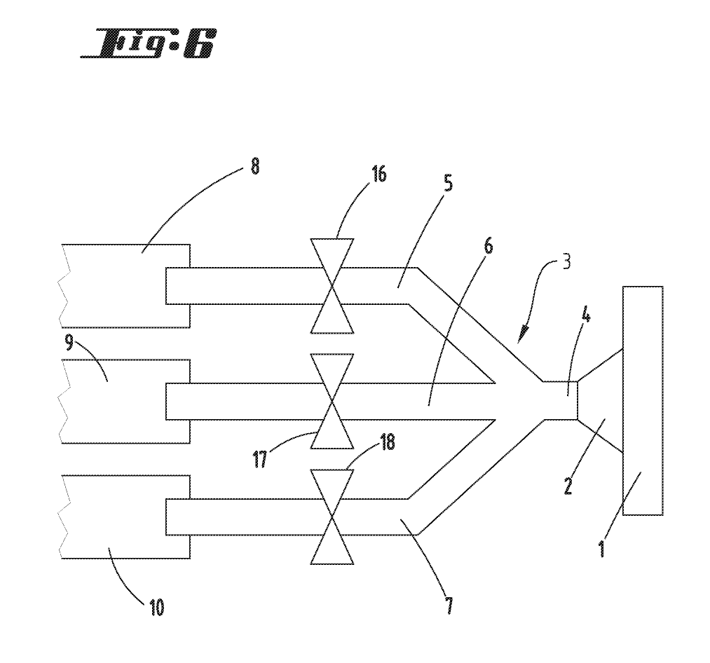

FIGS. 4 and 5 show a further exemplary embodiment, in the case of which the coupling element 3 as a whole is also embodied as a four-arm coupling pin. One coupling arm 4 is connected to a plurality of decoupling arms 5, 6, 7. Each decoupling arm 5, 6, 7 is connected to a waveguide 8, 9, 10. On a side wall of the cooking chamber 14, the waveguide 8 leads into the upper area thereof on a side wall and forms a feed point 11. On the rear side of the cooking chamber 14, the waveguide 9 leads to a feed point 12. Below the feed point 11 of the waveguide 8, the waveguide 10 leads into the cooking chamber 14 at a feed point 13.

In the case of the embodiment illustrated in FIG. 6, the total of three decoupling branches 5, 6, 7, which, together, are connected to a coupling branch 4, can optionally be brought from a power-transmitting operating position into a non-power-transmitting operating position. Suitable switching means 16, 17, 18 are provided for this purpose, by means of which the power transmission from the coupling end of the decoupling branch 5, 6, 7 to the decoupling end of the decoupling branch 5, 6, 7 can be interrupted.

Electromagnetic alternating fields can be coupled into the cooking chamber 14 at feed points 11, 12, 13, which spatially differ from one another, by means of the device according to the invention. They can thereby be polarized or non-polarized electromagnetic alternating fields. The feed points 11, 12, 13 are arranged on selected locations of the walls of the cooking chamber 14 such that the electromagnetic waves neither overlap constructively at 100 percent, nor destructively at 100 percent.

Electromagnetic alternating fields can be fed into the cooking chamber 14 at different feed points 11, 12, 13 in chronologically following steps by means of the switching elements 16, 17, 18, which, in a manner of speaking, have the function of valves. It is also possible to use different groups of feed points 11, 12, 13 for feeding the heating power.

The coupling element 3 can be an electrically conductive solid body, into which electromagnetic microwaves are fed. The solid body forks into a plurality of decoupling branches 5, 6, 7. As a result of this branching, the microwaves are distributed to a plurality of outputs. The decoupling branches 5, 6, 7 are preferably in each case connected to a waveguide 8, 9, 10, which guide the microwaves to the feed points 11, 12, 13.

The coupling element 3, however, can physically also be embodied differently. Its electronic property of distributing power, which is coupled into a coupling branch 4, to a plurality of decoupling branches 5, 6, 7, is essential. The coupling element 3 can thus also be embodied as branching waveguide. Each decoupling branch 5, 6, 7 can transition into a waveguide 8, which leads into the cooking chamber 14 at the feed point 11, 12, 13.

The switching elements identified with reference numerals 16, 17, 18 can block the power transmission through a decoupling branch 5, 6, 7. It is also possible, however, to only reduce the power transmission through a decoupling branch 5, 6, 7, so that the electromagnetic power, which is coupled into a coupling branch 4, can be transmitted to the decoupling branches 5, 6, 7 at varying ratios.

### LIST OF REFERENCE NUMERALS

1 microwave transmitter
2 microwave transmitter
3 coupling element
4 coupling branch
5 decoupling branch
6 decoupling branch
7 decoupling branch
8 waveguide
9 waveguide
10 waveguide
11 feed point
12 feed point
13 feed point
14 cooking chamber
15 housing
16 switching element
17 switching element
18 switching element

What is claimed is:

1. A device for feeding electromagnetic power in the form of an electromagnetic alternating field, which is generated by a microwave transmitter, into a cooking chamber of a microwave oven, comprising a transmission device configured for transmitting the electromagnetic alternating field in a power flow direction from the microwave transmitter to a plurality of feed points of the cooking chamber,
wherein the transmission device has a plurality of waveguides and a coupling element embodied as a power distributor in the form of a coupling pin having a plurality of arms, the coupling pin being configured for connecting the microwave transmitter to the plurality of waveguides.

2. The device according to claim 1, wherein the coupling element has a coupling branch, into which the power in the form of the electromagnetic alternating field is coupled, and a plurality of decoupling branches, to which the power, which is fed into the coupling branch, is distributed.

3. The device according to claim 2, wherein the power, which is coupled into the coupling branch, is distributed substantially evenly to the plurality of decoupling branches.

4. The device according to claim 2, wherein each decoupling branch is embodied as an arm of the coupling pin and is operatively connected to one of the waveguides, which is individually assigned thereto.

5. The device according to claim 1, wherein the feed points are arranged on at least two walls of the cooking chamber, which differ from one another.

6. The device according to claim 2, further comprising switching elements configured for bringing the decoupling branches individually from a power-transmitting operating position with respect to the coupling branch into a non-power-transmitting operating position to the coupling branch.

7. The device according to claim 6, wherein the switching elements are embodied so that the powers, which are decoupled via the decoupling branches, are variable.

8. A method for operating a microwave oven, comprising:
generating electromagnetic power with a microwave transmitter, and
transmitting the power into a cooking chamber of the microwave oven via a transmission device comprising a coupling element in the form of a coupling pin having a plurality of arms, wherein the power is transmitted from the coupling pin to a plurality of waveguides that lead into the cooking chamber at feed points.

9. The method according to claim 8, wherein the power fed into the coupling element is distributed or varied to a sub-number of the waveguides by switching elements in a time sequence.
